(19) United States
(12) Patent Application Publication
(10) Pub. No.: US 2026/0024334 A1
(43) Pub. Date: Jan. 22, 2026

(54) METHOD AND APPARATUS FOR AN APPLICATION OF REAL-TIME FRAME ADJUSTMENT ON A VIDEO STREAM

(71) Applicant: SAMSUNG ELECTRONICS CO., LTD., Suwon-si (KR)

(72) Inventors: Pulkit AGARAWAL, Noida (IN); Mohammad Taha RAZA, Noida (IN)

(73) Assignee: SAMSUNG ELECTRONICS CO., LTD., Suwon-si (KR)

(21) Appl. No.: 19/321,981

(22) Filed: Sep. 8, 2025

Related U.S. Application Data
(63) Continuation of application No. PCT/KR2025/010765, filed on Jul. 22, 2025.

(30) Foreign Application Priority Data
Jul. 22, 2024 (IN) 202411055699

(51) Int. Cl. G06V 20/40; G06V 10/82; G06V 40/16; G06V 40/20

(52) U.S. Cl. CPC G06V 20/46; G06V 10/82; G06V 20/41; G06V 40/174; G06V 40/20

(57) ABSTRACT

A method for real-time frame adjustment on a video stream, includes: obtaining, in real-time, one or more frames of the video stream; identifying one or more activities from the one or more frames; prioritizing one or more key focus areas from a set of key focus areas in the one or more activities; determining at least one of one or more target actions and one or more target effects, based on at least one of: a tracking of the one or more prioritized key focus areas, the set of key focus areas, and one or more activity categories of the one or more activities; and applying, in real-time, at least one of the one or more target effects and the one or more target actions to the one or more frames of the video stream.

### CROSS-REFERENCE TO RELATED APPLICATION(S)

This application is a continuation application, claiming priority under § 365 (c), of an International Application No. PCT/KR2025/010765, filed on Jul. 22, 2025, which is based on and claims the priority to Indian Patent Application number 202411055699, filed on Jul. 22, 2024, in the Indian Patent Office, the disclosures of which are incorporated by reference herein in their entireties.

### BACKGROUND

### 1. Field

The disclosure relates to video processing technology, and more particularly, to a method and apparatus for an application of real-time frame adjustment on a video stream.

### 2. Description of Related Art

The following description of the related art is intended to provide background information pertaining to the field of the disclosure. This section may include certain aspects of the art that may be related to various features of the present disclosure. However, it should be appreciated that this section is used only to enhance the understanding of the present disclosure, and not as admissions of the prior art.

Videography is the process of capturing video digitally, then editing and reproducing that video in a customized form. Videographers use media recording and streaming devices to record or stream video projects like recording a concert, documenting the news, or streaming a podcast or vlog.

With the rapid growth in videography or modern media production, video editing became one of the essential aspects for the influencers and content creators on digital platforms such as social media platforms and the like. It plays a vital role in shaping a video in a final or a desired format for the video editors. By selecting the right shots, adding music, and using visual effects strategically, the video editors can amplify the emotional resonance of a video and can leave a lasting impact on the audience/viewers.

In the past, there were only limited features for the video editors to enhance their recorded video but with the advancement in media technology, the video editing software have evolved dynamically. The video editing software have been enriched with editing capabilities, enhanced color grading, enabling the video editors to incorporate advanced visual effects. These visual effects provide more liveliness, imparting a dynamic and visually captivating element in the recorded videos.

However, one of the major limitations associated with the related art solutions is an inability to apply such visual effects in real-time. Further, the related art solutions of video processing do not provide any method to apply dynamic effects on a video stream in real-time or on the live video streams. A dynamic effect is a visual effect that customizes a video stream based on a viewer preference, and/or a person or an object captured in the video stream. Also, the dynamic effect facilitates customizing a video stream based on a movement of the person or the object captured in the video stream. More specifically, the dynamic effect may include an application of a frame movement in a video stream based on detection of motion effect(s) in the frame(s) of the video stream.

The related art solutions enable video editors to apply dynamic effects only on the recorded videos and does not provide any option to apply such dynamic effects in real-time. The users, such as influencers and content creators on the digital platforms, thus have to undergo with an extensive manual post processing to add liveliness in their recorded videos. Further, the video creators who work alone keep their camera fixed which restricts them to give dynamic effects such as camera follow effect etc. The camera follow effect is the process of tracking the movement of any specific point of body part or object within a video frame, wherein the video frame is moved in the direction of body part or object based on its velocity and acceleration.

Some other technical problems associated with the relate art are, for example, but not limited to: (1) a lack an efficient real time detection of people or objects in a field of view of a camera device, (2) a lack an efficient real time adjustment of all participants or objects in a same frame of a captured video to enhance the captured video, (3) no consideration of classification of types of activities like dance, vlogs, podcasts etc. in a video to enhance such video in real time, and (4) a lack on a real time application of a frame movement in a video based on a specific area(s) or a specific object(s) and their movements in the video.

The above-mentioned limitations and such other limitations of the related art solutions restrict the creativity and realism in the videos. Therefore, the users have to either shoot a video manually in such a way which adds frame movement (i.e., dynamic effect) while shooting with the help of another person, or the users have to go with manual post processing to apply the dynamic effects or real-time frame adjustment on the recorded video.

Thus, there exists a need for a technical solution that can overcome at least the above-mentioned technical limitations of the related art solutions. More specifically there is a need in the art to provide a method and a system for an application of real-time frame adjustment and/or real-time frame movement on a video stream that can seamlessly integrate the dynamic effects into the video stream in real-time.

### SUMMARY

According to an aspect of the disclosure, a method for real-time frame adjustment on a video stream, may include: obtaining, in real-time, one or more frames of the video stream; identifying one or more activities from the one or more frames; prioritizing one or more key focus areas from a set of key focus areas in the one or more activities; determining at least one of one or more target actions and one or more target effects, based on at least one of: a tracking of the one or more prioritized key focus areas, the set of key focus areas, and one or more activity categories of the one or more activities; and applying, in real-time, at least one of the one or more target effects and the one or more target actions to the one or more frames of the video stream.

The video stream may be a live camera feed video stream.

The identifying the one or more activities may include classifying the one or more activities in the one or more activity categories based on an analysis of the one or more frames using an artificial intelligence (AI) based activity classification engine.

The method may further include identifying the set of key focus areas in the one or more activities based at least on the one or more activity categories.

The prioritizing the one or more key focus areas may include prioritizing the one or more key focus areas from the set of key focus areas based on at least one of an effect intensity and the one or more activity categories.

The tracking the one or more prioritized key focus areas may include tracking at least one of: one or more actions corresponding to the one or more prioritized key focus areas, one or more gestures corresponding to the one or more prioritized key focus areas, and one or more motion parameters corresponding to the one or more gestures.

The determining the at least one of the one or more target actions and the one or more target effects is further based on the tracking of at least one of the one or more actions, the one or more gestures, and the one or more motion parameters.

The identifying the set of key focus areas may be performed using a multi-focus recognition system including of at least one of a body tracking system, a facial expression tracking system and an object tracking system, and each key focus area from among the set of key focus areas may be one of a body part, an object and a facial expression.

The prioritizing the one or more key focus areas may be performed at a frame level and by using an artificial intelligence (AI) based priority identifier neural engine.

The effect intensity may be one of a user defined effect intensity and an automatically defined effect intensity.

The tracking the one or more actions may be performed by using a body area tracking system, and the tracking of at least one of the one or more gestures and the one or more motion parameters may be performed using a gesture tracking system.

The determining the at least one of the one or more target effects and the one or more target actions may be performed using an artificial intelligence (AI) based recommender neural engine.

The analysis of the one or more frames using the artificial intelligence (AI) based activity classification engine may include classifying the one or more frames into the one or more activities using at least one of: one or more three-dimensional convolutional neural network (3D CNN) engines, wherein each 3D CNN engine from among the one or more 3D CNN engines is pre-trained based on a plurality of activities, and one or more Visual Question Answering (VQA) engines.

The identifying the set of key focus areas may include: processing, the one or more frames of the video stream, and at least one of the one or more activities and the one or more activity categories using at least one of the body tracking system, the facial expression tracking system and the object tracking system, identifying, at least one of: a set of trackable body focus areas based on the processing the one or more frames of the video stream, and at least one of the one or more activities and the one or more activity categories using the body tracking system, a first set of trackable focus area vectors based on the processing the one or more frames of the video stream, and at least one of the one or more activities and the one or more activity categories using the body tracking system, a second set of trackable focus area vectors based on the processing the one or more frames of the video stream, and at least one of the one or more activities and the one or more activity categories using the facial expression tracking system and the object tracking system, and a set of identified gestures, a set of trackable gestures, and a set of gesture types based on the processing the one or more frames of the video stream, and at least one of the one or more activities and the one or more activity categories using the facial expression tracking system and the object tracking system, and identifying the set of key focus areas based on at least one of the set of trackable body focus areas, the first set of trackable focus area vectors, the second set of trackable focus area vectors, the set of identified gestures, the set of trackable gestures, and the set of gesture types.

The AI based priority identifier neural engine may be trained based on at least one of a plurality of activity categories, a plurality of activity intensities, a plurality of trackable body focus areas, a plurality of gestures, a plurality of trackable gestures, a plurality of gesture types, and a plurality of trackable focus area vectors.

According to an aspect of the disclosure electronic, an apparatus includes: a camera; at least one processor; and memory including one or more storage mediums storing one or more instructions, wherein the one or more instructions, when executed by the at least one processor individually or collectively, cause the electronic apparatus to: obtain, in real-time using the camera, one or more frames of the video stream, identify one or more activities from the one or more frames, prioritize one or more key focus areas from a set of key focus areas in the one or more activities, determine at least one of one or more target actions and one or more target effects, based on at least one of: a tracking of the one or more prioritized key focus areas, the set of key focus areas, and one or more activity categories of the one or more activities, and apply, in real-time, at least one of the one or more target effects and the one or more target actions to the one or more frames of the video stream.

According to an aspect of the disclosure, a non-transitory computer readable storage medium stores instructions that when executed by at least one processor of an electronic device cause the electronic device to perform a method for real-time frame adjustment on a video stream, the method including: obtaining, in real-time, one or more frames of the video stream; identifying one or more activities from the one or more frames; prioritizing one or more key focus areas from a set of key focus areas in the one or more activities; determining at least one of one or more target actions and one or more target effects, based on at least one of: a tracking of the one or more prioritized key focus areas, the set of key focus areas, and one or more activity categories of the one or more activities; and applying, in real-time, at least one of the one or more target effects and the one or more target actions to the one or more frames of the video stream.

One or more embodiments provide real-time frame adjustment/modification on a video stream.

One or more embodiments provide in a video stream in real time, one or more dynamic effects like synchronized frame movement with respect to any object or a body part in the video stream.

One or more embodiments provide a method and apparatus for applying in real time one or more frame movement effects as per an identified activity in a video stream.

One or more embodiments provide a method and apparatus real time frame adjustment/modification in a video stream with reduced manual efforts.

One or more embodiments provide a method and apparatus for identifying in real time trackable focus area(s) in video frame(s) of a video stream, and intelligently prioritizing the trackable focus area(s) for tracking the prioritized trackable focus area(s) in real time.

One or more embodiments provide a method and apparatus for determining and/or recommending target action(s) and/or target effect(s) in real time based on trackable focus area(s), and/or tracking of the prioritized trackable focus area(s), and/or one or more activity categories.

One or more embodiments provide a method and apparatus real-time frame adjustment or applying dynamic effect(s) on a video stream based on target action(s) and/or target effect(s) that are determined in real time.

One or more embodiments provide a method and apparatus for real time detecting and real time tracking of a vertical, a horizontal, and/or a depth motion of prioritized trackable focus area(s).

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an example block diagram of a system for an application of real-time frame adjustment on a video stream, in accordance with one or more embodiments of the present disclosure;

FIG. 2 illustrates an example block diagram of a system comprising example modules for an application of real-time frame adjustment on a video stream, in accordance with one or more embodiments of the present disclosure;

FIG. 3 illustrates an example method flow diagram of a method for an application of real-time frame adjustment on a video stream, in accordance with one or more embodiments of the present disclosure;

FIG. 4 illustrates an example functionality of an example activity understanding module for an application of real-time frame adjustment on a video stream, in accordance with one or more embodiments of the present disclosure;

FIG. 5 illustrates an example functionality of an example focus area identifier for an application of real-time frame adjustment on a video stream, in accordance with one or more embodiments of the present disclosure;

FIG. 6 illustrates an example functionality of an example focus priority system for an application of real-time frame adjustment on a video stream, in accordance with one or more embodiments of the present disclosure;

FIG. 7 illustrates an example training process of an artificial intelligence (AI) neural network model inside the example focus priority system for an application of real-time frame adjustment on a video stream, in accordance with one or more embodiments of the present disclosure;

FIG. 8 illustrates example functional details of an example body area tracking system for an application of real-time frame adjustment on a video stream, in accordance with one or more embodiments of the present disclosure;

FIG. 9 illustrates example functional details of an example gesture tracking system for an application of real-time frame adjustment on a video stream, in accordance with one or more embodiments of the present disclosure;

FIG. 10 illustrates example functional details of an example intelligent effect recommender for an application of real-time frame adjustment on a video stream, in accordance with one or more embodiments of the present disclosure; and

FIG. 11 illustrates an example training process of an artificial intelligence (AI) neural network model inside the example intelligent effect recommender for an application of real-time frame adjustment on a video stream, in accordance with one or more embodiments of the present disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter may each be used independently of one another or with any combination of other features. An individual feature may not address any of the problems discussed above or might address only some of the problems discussed above.

The ensuing description provides example embodiments only, and is not intended to limit the scope, applicability, or configuration of the disclosure. Rather, the ensuing description of the example embodiments will provide those skilled in the art with an enabling description for implementing example embodiments. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure.

The word “example” and/or “demonstrative” is used herein to mean serving as an example, instance, or illustration. For the avoidance of doubt, the subject matter disclosed herein is not limited by such examples. In addition, any aspect or design described herein as “example” and/or “demonstrative” is not necessarily to be construed as preferred or advantageous over other aspects or designs, nor is it meant to preclude equivalent example structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

As used herein, expressions such as “at least one of,” when preceding a list of elements, modify the entire list of elements and do not modify the individual elements of the list. For example, the expression, “at least one of A, B, and C,” should be understood as including only A, only B, only C, both A and B, both A and C, both B and C, or all of A, B, and C.

As used herein, “a user equipment”, “a user device”, “a smart-user-device”, “a smart-device”, “an electronic device”, “a mobile device”, “a handheld device”, “a mobile communication device”, or the like may be any electrical, electronic and/or computing device or equipment, capable of implementing one or more features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure.

As used herein, “storage” or “memory” refers to a machine or computer-readable medium including any mechanism for storing information in a form readable by a computer or similar machine. For example, a computer-readable medium includes read-only memory (ROM), random access memory (RAM), magnetic disk storage media, optical storage media, flash memory devices or other types of machine-accessible storage media. The memory stores at least the data that may be required by one or more units of the system to perform their respective functions.

As used herein, a “user interface” typically includes an output device in the form of a display, such as a liquid crystal display (LCD), cathode ray tube (CRT) monitors, light emitting diode (LED) screens, etc. and/or one or more input devices such as touchpads or touchscreens. The display may be a part of a portable electronic device such as smartphones, tablets, mobile phones, wearable devices, etc. They also include monitors or LED/LCD screens, television screens, etc. that may not be portable. The display is typically configured to provide visual information such as text and graphics. An input device is typically configured to perform operations such as issuing commands, selecting, and moving a cursor or selector in an electronic device.

All modules, units, components used herein, unless explicitly excluded herein, may be software modules or hardware processors, the processors being a general-purpose processor, a special purpose processor, a conventional processor, a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuits, etc.

One or more of the plurality of modules may be implemented through an AI model. A function associated with AI may be performed through the non-volatile memory, the volatile memory, and the processor. The processor may include one or a plurality of processors. For implementing the one or the plurality of modules through an AI model, the one or the plurality of processors may be a general purpose processor(s), such as a central processor (CPU), an application processor (AP), or the like, a graphics-only processor such as a graphics processor (GPU), a visual processor (VPU), and/or an AI-dedicated processor such as a neural processor (NPU). The one or the plurality of processors control the processing of the input data in accordance with a predefined operating rule or artificial intelligence (AI) model stored in the non-volatile memory and the volatile memory. The predefined operating rule or artificial intelligence model is provided through training or learning. Here, being provided through learning means that, by applying a learning algorithm(s) to a plurality of learning data, a predefined operating rule or AI model of a desired characteristic is made. The learning may be performed in a device itself in which AI according to an embodiment is performed, and/or may be implemented through a separate server/system. The AI model may consist of a plurality of neural network layers, such as long short-term memory (LSTM) layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

Also, a learning algorithm refers to a method for training a device (for example, a robot) using a plurality of learning data to cause, allow, or control the device to make a determination or prediction. Examples of learning algorithms include, but are not limited to, supervised learning, unsupervised learning, semi-supervised learning, or reinforcement learning.

As discussed in the background section, related art technologies related to real time frame modification for a video stream have many limitations, and in order to overcome at least some of the limitations of the prior known solutions, the present disclosure provides a solution for an application of real-time frame adjustment on a video stream. In an embodiment the video stream is a live camera feed video stream. In order to apply the real-time frame adjustment on the video stream, one or more frames associated with the video stream are first received in real-time. Then, one or more activities are identified from the one or more frames. Thereafter, these one or more activities are classified in one or more activity categories such as, but not limited to, a vlog category, a podcast category, and/or a dance category, etc. For example, if the one or more frames show that a person is dancing in the video stream, then the activity may be identified as “dance” and the activity “dance” is then classified in an activity category say, “dance category”. Also, a set of key focus areas are then identified in the identified one or more activities. A key focus area may be, but not limited to, a body part, an object, or a facial expression, etc. Further, one or more key focus areas are prioritized from the set of key focus areas for tracking. Further, a set of target actions and/or a set of target effects are determined based on a tracking of the prioritized key focus area(s), the set of key focus areas, and/or the one or more activity categories. Finally, the target effect(s) and/or the target action(s) are applied on the frame(s) of the video stream the real-time frame adjustment on the video stream.

Hereinafter, embodiments of the present disclosure will be described in detail with reference to the accompanying drawings.

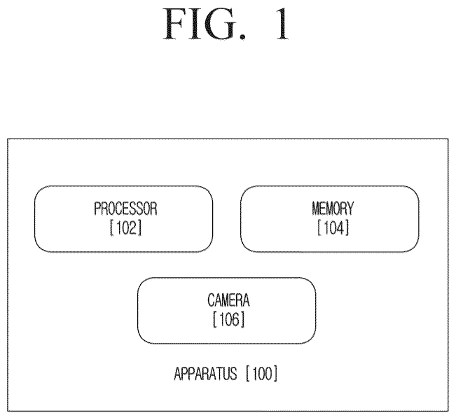

Referring to FIG. 1, an example block diagram of an apparatus or system (hereafter referred to as “the system”) 100 for an application of real-time frame adjustment on a video stream, in accordance with one or more embodiments of the present disclosure is shown. The system 100 includes at least one processor 102 (hereafter “the processor”), memory 104 and at least one camera 106 configured to capture a video stream. Also, all of the components/units of the system 100 are assumed to be connected to each other unless otherwise indicated below. Also, although only two components are shown in FIG. 1, the system 100 may include multiple such units, or the system 100 may include any such numbers of the units, as required to implement the features of the present disclosure. Further, in an embodiment, the system 100 may reside in and/or connected to and/or in communication with a user device (may also be referred herein as a user equipment (UE)) to implement the features of the present disclosure. In another embodiment, the system 100 may reside in a server. Also, the processor 102 is configured to receive, in real-time, one or more frames associated with the video stream. In an embodiment, the video stream is a live camera feed video stream. Also, in an embodiment the one or more frames are received in one or more batches. Further, the processor 102 is configured to identify one or more activities from the one or more frames. These one or more activities may be identified in scene(s) or visual(s) that are present in the frame(s) of the video. For example, in an event where visuals in frames of a video stream show that a person is dancing, then the activity or the scene may be ‘dancing’. In another example, in case the visuals in the frames show that a person is interviewing, then the activity or the scene may be ‘interviewing’. Thus, the activities may be construed as scenes. Further, the processor 102 is configured to classify the one or more activities in one or more activity categories. For example, in case the visuals in the frames show that a person is dancing, then the activity may be identified as “dance”, and the activity category may be ‘dance category’. Further, the processor 102 is configured to identify a set of key focus areas in the one or more activities. Thereafter, the processor 102 is configured to prioritize one or more key focus areas from the set of key focus areas in the one or more identified activities. The processor 102 is then configured to track the one or more prioritized key focus areas. Further, the processor 102 is configured to determine at least one of one or more target actions and one or more target effects, based on at least one of the tracking of the one or more prioritized key focus areas, the set of key focus areas, and the one or more activity categories. Thereafter, the processor 102 is configured to apply, in real-time, at least one of the one or more target effects and the one or more target actions on one or more frames of the video stream for the application of the real-time frame adjustment on the video stream.

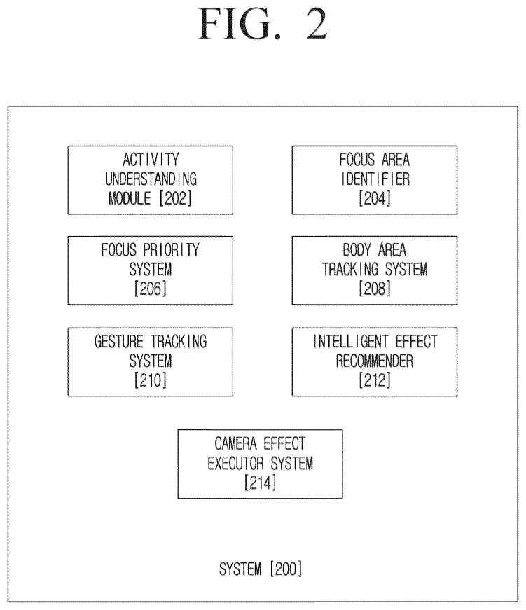

Referring to FIG. 2, an example block diagram of a system 200 including example modules for an application of real-time frame adjustment on a video stream, in accordance with one or more embodiments of the present disclosure is shown. Further, the system 200, in an embodiment, includes the example modules to implement one or more features of the present disclosure. These example modules as shown in FIG. 2, in an embodiment, may be implemented by the processor 102 of the system 100. As shown in FIG. 2, the system 200 includes an activity understanding module 202, a focus area identifier 204, a focus priority system 206, a body area tracking system 208, a gesture tracking system 210, an intelligent effect recommender 212, and a camera effect executor system 214. Each of these modules may be explained in detail with reference to one or more figures in the forthcoming description. Further, for the application of the real-time frame adjustment on the video stream, other associated software components may also be used. For example, a camera software development kit (SDK), a driver (such as a display driver, and/or a driver relate to time of flight sensors, etc.), operating system components (such as device managers for batteries, display, and/or other applications, etc.), and memory, etc. may be used for an embodiment of the target effect(s) and/or the target action(s) dynamically on the video stream, wherein these other associated software components are used in conjunction with the system 100 and the system 200.

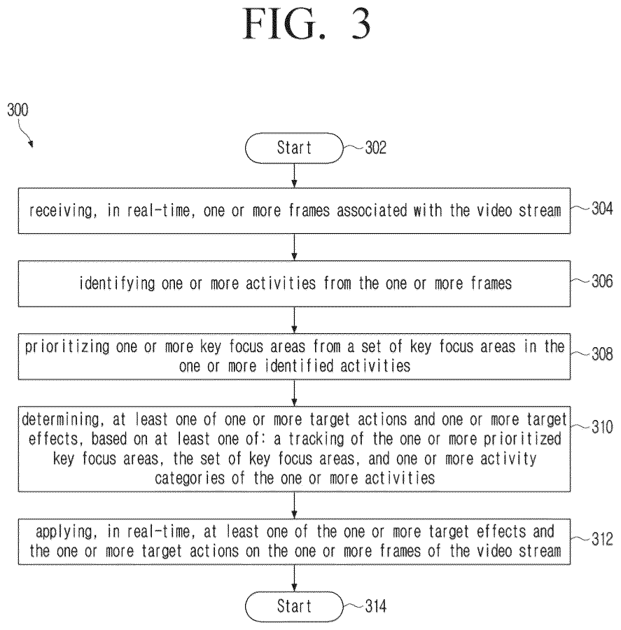

Referring to FIG. 3, an example method flow diagram of a method 300 for the application of the real-time frame adjustment on the video stream, in accordance with one or more embodiments of the present disclosure is shown. In an embodiment, the method 300 may be performed by the system 100. Also, in an embodiment the system 100 performs the method 300 in conjunction with the system 200.

As shown in FIG. 3, the method 300 starts at step 302 and goes to step 304. In an embodiment the method 300 is triggered at step 302, where a user may access a camera device for the application of real-time frame adjustment on the video stream, wherein the video stream is a live camera feed video stream. The camera device is configured with the system 100, the system 200 and camera unit(s) to receive the live camera feed video stream. Furthermore, in another embodiment, the method 300 may be triggered at step 302 upon accessing a device for receiving at the device the video stream in real time, wherein such video stream is not limited to the live camera feed video stream and may also include any video stream that may be received in real time such as a broadcasted video feed, a real time Augmented Reality (AR) video feed or a real time Virtual Reality (VR) video feed, etc. The camera device or the device may be a smartphone and is configured with the system 100 and the system 200 for implementation of feature(s) as disclosed in the present disclosure, but the present disclosure is not limited thereto. A person skilled in the art will appreciate that the camera device or the device may be any electronic device that in conjunction with the system 100 and the system 200 is capable of implementation of feature(s) as disclosed in the present disclosure.

After accessing the camera device or the device at step 302, the method includes receiving, in real-time at the at least one processor 102, one or more frames associated with the video stream at step 304. As noted above, in an embodiment, the video stream may be the live camera feed video stream, or in another embodiment, the video stream may be any video stream that may be received in a real time such as a broadcasted video feed, a real time AR video feed or a real time Virtual Reality (VR) video feed etc. The one or more frames may be one or more time-lapsed frames, wherein a time-lapsed frame is a frame associated with a frame rate that provides a time-lapsed effect as known to a person skilled in the art. In an embodiment, the one or more frames are received in one or more batches. Also, each batch from the one or more frames is associated with a batch size. In an embodiment, the batch size is based on one or more activity categories associated with the video stream, wherein prior to receiving the one or more frames, an option for selection of the one or more activity categories may be provided and then based on the one or more selected activity categories the batch size is determined and according to the determined batch size the one or more frames are received in the one or more batches. In another embodiment, the batch size may be preconfigured at the system 100 or the system 200, wherein such pre-configuration of the batch size may be based on one or more parameters such as including but not limited to a video resolution of the video stream or a configuration of a camera unit capturing the video stream etc. For instance, four batches of time-lapsed frames of a live camera feed video stream say for e.g., batch A of 2 Kilobyte (KB) including 5 time-lapsed frames, batch B of 1 KB including 2 time-lapsed frames, batch C of 2 KB including 8 time-lapsed frames, and batch D of 4 KB including 12 time-lapsed frames may be received. In the given instance in one scenario the batch size of each batch from the four batches is based on a selected activity category such as a podcast category, or in the other scenario the batch size of each batch from the four batches may be preconfigured at the system 100 or the system 200. Also, in an embodiment, each scene/activity category from the one or more scene/activity categories is one of a dance category, a Vlog category, a social media category, a podcast category, and an interview category, however the disclosure is not limited thereto and a person skilled in the art would appreciate that an activity category may be any such other category depending on a use case or implementation.

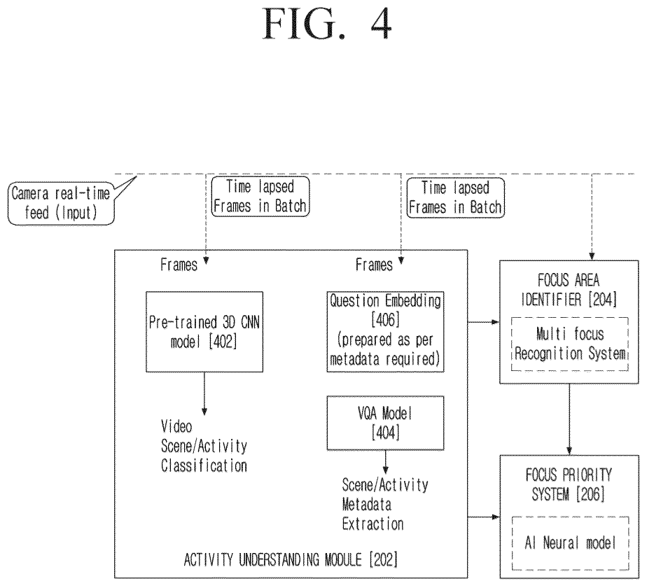

Next, after receiving the one or more frames in the real-time, at step 306 the method includes identifying one or more activities from the one or more frames. Further, in an embodiment, the method includes classifying the one or more activities in the one or more activity categories. This feature of identification and classification of the one or more activities, in an embodiment, may be performed by the processor 102 using the activity understanding module 202, further details of which are provided with reference to FIG. 4. In an embodiment, the identification of the one or more activities and the classification of the one or more activities in the one or more activity categories is based on an analysis of the one or more frames using an artificial intelligence (AI) based activity classification engine. Also, in an embodiment, the analysis of the one or more frames using the artificial intelligence (AI) based activity classification engine includes classifying, the one or more frames into the one or more activities using at least one of: (a) one or more three-dimensional convolutional neural network (3D CNN) engines/models, wherein each 3D CNN engine from the one or more 3D CNN engines is pre-trained based on a plurality of activities, and (b) one or more Visual Question Answering (VQA) engines/models.

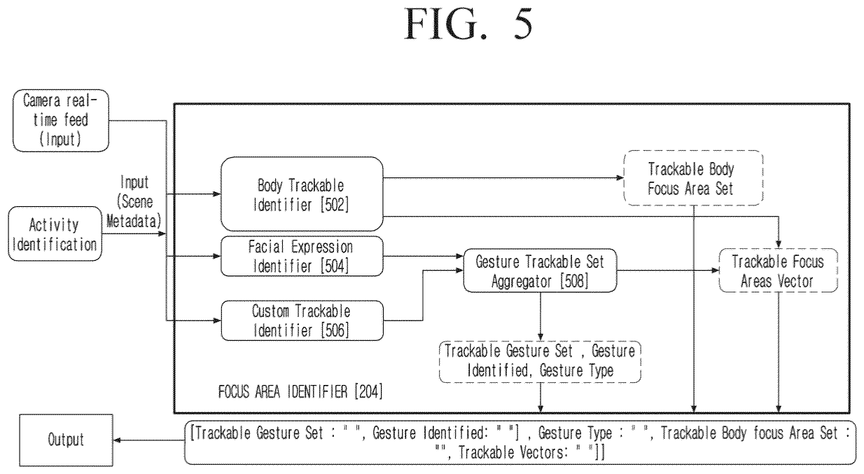

Furthermore, the method includes identifying a set of key focus areas in the one or more activities. This feature of identification of the set of key focus areas, in an embodiment, may be performed by the processor 102 using the focus area identifier 204, further details of which are provided with reference to FIG. 5. In an embodiment, the set of key focus areas are identified in the one or more activities based at least on the one or more activity categories. Also, in an embodiment, the identification of the set of key focus areas is performed using a multi-focus recognition system including of at least one of a body tracking system, a facial expression tracking system and an object tracking system, and wherein each key focus area from the set of key focus areas is one of a body part, an object and a facial expression.

Further, in an embodiment, the identification of the set of key focus areas using the multi-focus recognition system includes processing, the one or more frames associated with the video stream, and at least one of the one or more activities and the one or more activity categories, using at least one of the body tracking system, the facial expression tracking system and the object tracking system. Further, the identification of the set of key focus areas using the multi-focus recognition system includes identifying, at least one of: (a) a set of trackable body focus areas based on the processing of the one or more frames associated with the video stream, and at least one of the one or more activities and the one or more activity categories, using the body tracking system, (b) a first set of trackable focus area vectors based on the processing of the one or more frames associated with the video stream, and at least one of the one or more activities and the one or more activity categories, using the body tracking system, (c) a second set of trackable focus area vectors based on the processing of the one or more frames associated with the video stream, and at least one of the one or more activities and the one or more activity categories, using the facial expression tracking system and the object tracking system, and (d) a set of identified gestures, a set of trackable gestures, and a set of gesture types based on the processing of the one or more frames associated with the video stream, and at least one of the one or more activities and the one or more activity categories, using the facial expression tracking system and the object tracking system. Further, the identification of the set of key focus areas using the multi-focus recognition system includes identifying, the set of key focus areas based on at least one of the set of trackable body focus areas, the first set of trackable focus area vectors, the second set of trackable focus area vectors, the set of identified gestures, the set of trackable gestures, and the set of gesture types. Also, in an embodiment, each gesture from the one or more gestures is one of a finger snap gesture, a hand wave gesture, an eye blink gesture, and a raised eyebrow gesture, however the disclosure is not limited thereto.

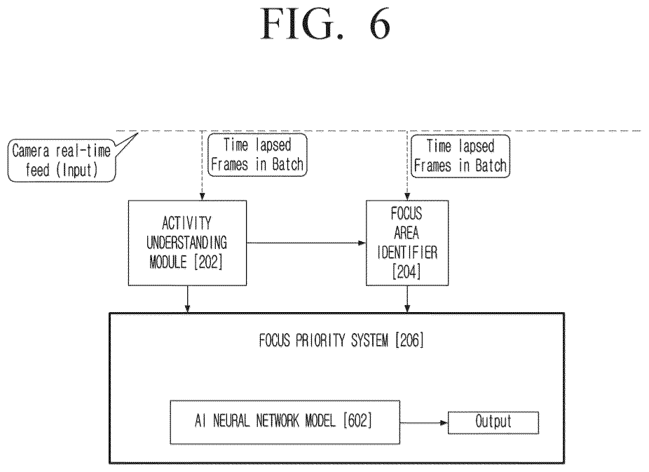

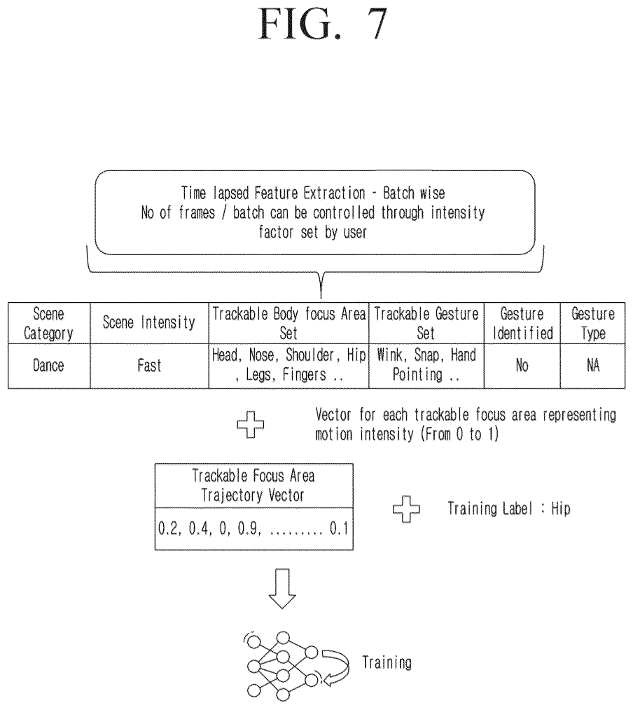

Further, at step 308, the method includes prioritizing one or more key focus areas from the set of key focus areas in the one or more identified activities. This feature of prioritizing the one or more key focus areas, in an embodiment, may be performed by the processor 102 using a focus priority system 206, further details of which are provided with reference to FIG. 6. In an embodiment, the one or more key focus areas are prioritized from the set of key focus areas based on at least one of an effect intensity and the one or more activity categories. In an embodiment, this effect intensity is one of a user defined effect intensity and an automatically defined effect intensity. In an embodiment, the prioritization is performed at a frame level and by using an artificial intelligence (AI) based priority identifier neural engine. Further, in an embodiment, the AI based priority identifier neural engine is trained based on at least one of a plurality of activity categories, a plurality of activity intensities, a plurality of trackable body focus areas, a plurality of gestures, a plurality of trackable gestures, a plurality of gesture types, and a plurality of trackable focus area vectors, further details of which are provided with reference to FIG. 7.

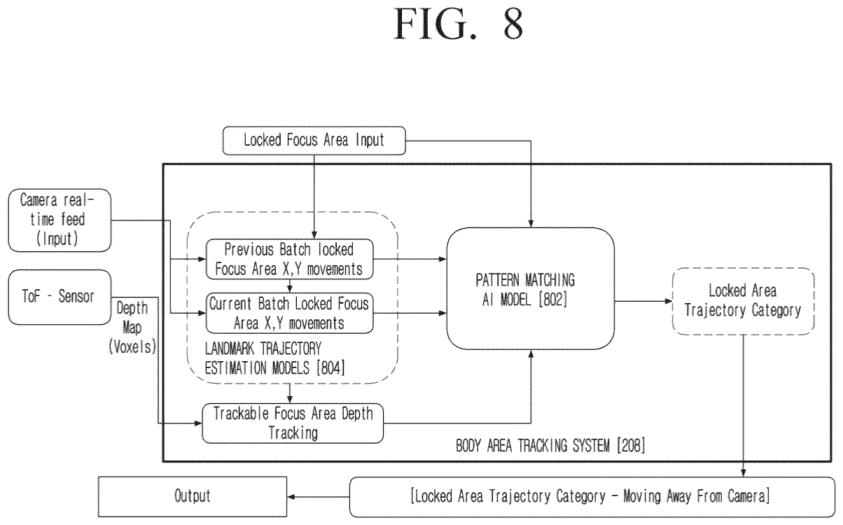

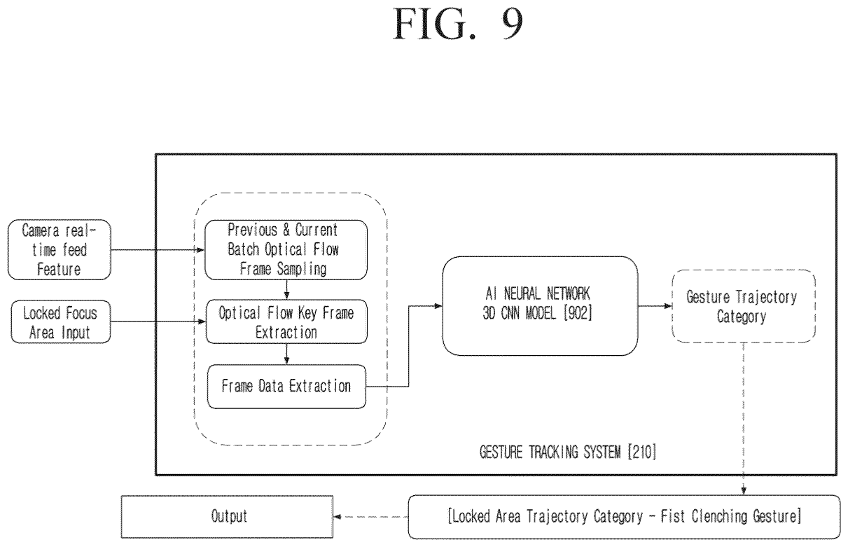

Further, in an embodiment, the method includes tracking the one or more prioritized key focus areas. In an embodiment, the tracking of the one or more prioritized key focus areas includes tracking at least one of: (a) one or more actions corresponding to the one or more prioritized key focus areas, (b) one or more gestures corresponding to the one or more prioritized key focus areas, and (c) one or more motion parameters corresponding to the one or more gestures. Also, in an embodiment, each action from the one or more actions is one of a moving forward action, a moving backward action, a moving away from frame action, a jumping up action, and a sitting down action, however the disclosure is not limited thereto. Further, in an embodiment, the tracking of the one or more actions is performed by using a body area tracking system 208, further details of which are provided with reference to FIG. 8. Also, the tracking of at least one of the one or more gestures and the one or more motion parameters is performed using a gesture tracking system 210, further details of which are provided with reference to FIG. 9. Also, in an embodiment, each motion parameter from the one or more motion parameters is one of a finger snap parameter, a hand wave parameter, an eye blink parameter, and a raised eyebrow parameter, however the disclosure is not limited thereto.

In an embodiment, for the tracking of the one or more actions, the method includes receiving, at the body area tracking system 208, an input data including the one or more prioritized key focus areas, the one or more frames associated with the video stream, and a time-of-flight data associated with the video stream. Further, in this embodiment, the method includes processing, by the body area tracking system 208, the input data. Further, in this embodiment, the method includes determining, by the body area tracking system 208, a movement corresponding to the one or more prioritized key focus areas in the one or more frames, based on the processing of the input data. Further, in this embodiment, the method includes tracking, by the body area tracking system 208, one or more trackable focus area depths based on the processing of the input data and the movement corresponding to the one or more prioritized key focus areas. Further, in this embodiment, the method includes tracking, by the body area tracking system 208, the one or more actions based on the tracking of the one or more trackable focus area depths and the movement corresponding to the one or more prioritized key focus areas.

In an embodiment, for the tracking of at least one of the one or more gestures and the one or more motion parameters the method includes processing, using the gesture tracking system 210, the one or more prioritized key focus areas, and the one or more frames associated with the video stream. This processing, in an embodiment, includes: (a) performing an optical flow frame sampling process on the one or more frames, and (b) performing at least one of an optical flow key frame extraction process and a frame data extraction process on the one or more frames based on the one or more prioritized key focus areas. Further, in this embodiment, the method includes determining, using the gesture tracking system 210, at least one of a set of spatial dimension characteristics corresponding to a set of gestures, and a set of temporal dimension characteristics corresponding to the set of gestures, based on the processing of the one or more prioritized key focus areas and the one or more frames. The gesture tracking system 210, in an embodiment, is an artificial intelligence (AI) based three-dimensional convolutional neural network (3D CNN) engine/model that is trained based on a plurality of video frames including of a plurality of gestures. Further, in this embodiment, the method includes tracking, using the gesture tracking system 210, at least one of the one or more gestures and the one or more motion parameters, based on at least one of the set of spatial dimension characteristics and the set of temporal dimension characteristics.

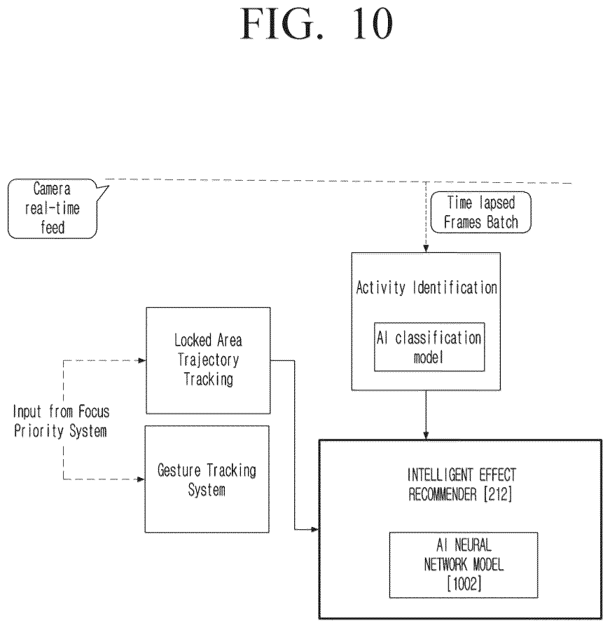

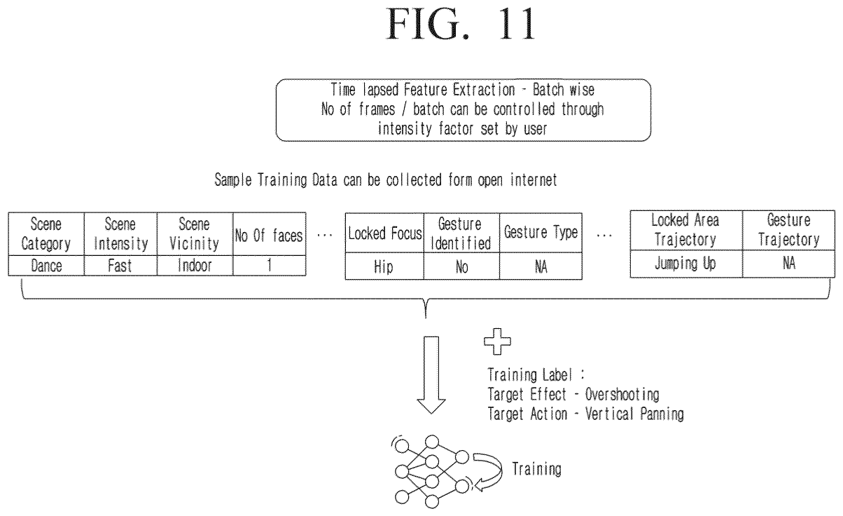

Further, at step 310, the method includes determining at least one of: one or more target actions, and one or more target effects, based on at least one of the tracking of the one or more prioritized key focus areas, the set of key focus areas, and the one or more activity categories. This feature of determining target actions and target effects, in an embodiment, may be performed by the processor 102 using an intelligent effect recommender 212, further details of which are provided with reference to FIG. 10. In an embodiment, this determining is further based on the tracking of at least one of the one or more actions, the one or more gestures, and the one or more motion parameters. Also, in an embodiment, the determination of at least one of the one or more target effects and the one or more target actions is performed using an artificial intelligence (AI) based recommender neural engine. Also, in an embodiment, the AI based recommender neural engine is trained based on at least one of a plurality of activity categories, a plurality of activity intensities, a plurality of activity vicinities, a number of faces, a plurality of prioritized key focus areas, a plurality of gestures, a plurality of gesture types, a plurality of actions, and a plurality of motion parameters, further details of which are provided with reference to FIG. 11. Also, in an embodiment, each target action from the one or more target actions is a zoom in action, a zoom out action, a toggle action, a panning up action, a panning down action, a panning in action and a panning out action, however the disclosure is not limited thereto. Furthermore, in an embodiment, each target effect from the one or more target effects is one of an overshooting target effect, a bouncy target effect, an accelerate target effect, and a linear target effect, however the disclosure is not limited thereto.

Further, at step 312, the method includes applying, in real-time, at least one of the one or more target effects and the one or more target actions on one or more frames of the video stream for the application of the real-time frame adjustment on the video stream. This feature of applying the target actions and target effects, in an embodiment, may be performed by the processor 102 using a camera effect execution system 214. In an embodiment, this applying is based on one of a manual indication and an automatic indication.

The method of FIG. 3 terminates at step 314, which may involve displaying the final output at a user interface of the device or the camera device. This final output may include the video stream with an applied dynamic effect, wherein the dynamic effect is produced based on the application of the real-time frame adjustment (i.e., application of the target effect(s) and/or target action(s)) on the video stream.

Referring to FIG. 4, an example functionality of an example activity understanding module 202 for an application of real-time frame adjustment on a video stream, in accordance with one or more embodiments of the present disclosure is shown. After, receiving, in real-time, one or more frames associated with the video stream, the activity understanding module 202 may facilitate identification of one or more activities from the one or more frames, and classification of the one or more activities in one or more activity categories. For this purpose, the activity understanding module 202 may implement an artificial intelligence (AI) based activity classification engine using which the identification of the one or more activities and the classification of the one or more activities may be performed. This artificial intelligence (AI) based activity classification engine may implement a pre-trained three-dimensional convolutional neural network (3D CNN) model/engine. This 3D CNN model facilitates in video activity classification (i.e., the classification of the one or more activities) based on an activity understanding. The activity understanding involves identifying the one or more activity categories by analyzing semantically similar shots/frames and classifying activities that are being performed in the semantically similar shots/frames. For example, the activities may include such as, but not limited to, walking, running, dancing, vlogging, live streaming on social media platforms, podcasts, playing sports, interview, etc. For the classification of activities, the time lapsed frames may be fed to the 3D CNN model(s). The 3D CNN model is trained based on the known techniques to classify the activities in one or more activity categories from a list of activity categories, for example, a dancing category, a vlogging category, an interview category, and/or a podcast category, etc. Further, the activity understanding module 202 may also facilitate extraction of an activity metadata through visual question answering (VQA) model(s) 404. For this purpose, a question embedding 406 for the one or more frames associated with the video stream may be prepared according to the requirement of the activity metadata. This question embedding and the one or more frames may be fed to the VQA model(s). The VQA model(s) may extract activity metadata from the one or more frames. This activity metadata may include information such as, but not limited to, activity movement intensity, indoor/outdoor visuals, and/or single/multiple face, etc. Thus, in an embodiment, the analysis of the one or more frames using the artificial intelligence (AI) based activity classification engine includes classifying, the one or more frames into the one or more activities using at least one of: (a) one or more three-dimensional convolutional neural network (3D CNN) engines, wherein each 3D CNN engine from the one or more 3D CNN engines is pre-trained based on a plurality of activities, and (b) one or more Visual Question Answering (VQA) engines. Further, as shown in FIG. 4, the output of the activity understanding module 202 may be fed to the focus area identifier 204 and the focus priority system 206.

Referring to FIG. 5, an example functionality of an example focus area identifier 204 for an application of real-time frame adjustment on a video stream, in accordance with one or more embodiments of the present disclosure is shown.

After the identification and the classification of the one or more activities, by the activity understanding module 202, from the one or more frames, the focus area identifier 204 may identify a set of key focus areas. In an embodiment, the set of key focus areas are identified in the one or more activities based at least on the one or more activity categories. For example, if the activity category is identified as dancing category, the key focus area may be identified as body of the dancer in the video. Similarly, for example, if the activity category is identified as interview, the key focus area may be identified as face of the person in the video. Further, the focus area identifier 204, in an embodiment, may classify the set of key focus areas (or referred herein as trackable focus area) into body, facial expression, custom trackable area through its three major components, namely, the body trackable identifier (or the body tracking system) 502, the facial expression identifier (or the facial expression tracking system) 504, and the custom trackable identifier (or the object tracking system) 506. That is, in an embodiment, the identification of the set of key focus areas is performed using a multi-focus recognition system including of at least one of a body tracking system 502, a facial expression tracking system 504, and an object tracking system 506. Also, each key focus area from the set of key focus areas is one of a body part, an object, and a facial expression.

Also, as shown in FIG. 5, the body trackable identifier 502, the facial expression identifier 504, and the custom trackable identifier 506 obtain inputs from the camera real-time feed and the activity understanding module (which provides activity identification as output to be fed to the focus area identifier 204). In an embodiment, the body trackable identifier 502 may implement one or more pose detection models. The one or more pose detection models may provide a trackable body focus area set. For example, if a video contains a belly dance performance, the pose detection models may identify the belly of the dancer as the focus area. Further, the body trackable identifier 502 after detecting the trackable body focus area (for example, belly, head, neck, shoulder, etc.) may also facilitate generation of one or more trackable focus areas vectors. Also, in an embodiment, facial expression identifier 504 may identify facial expressions in the video frames, such as, but not limited to, anger, happiness, fear, etc. Further, the custom trackable identifier 506 may implement an AI model trained based on custom gestures datasets. Thus, the custom trackable identifier 506 may identify other body parts/objects based on other gestures or the movements that, say for example, a person makes in the video frames. For example, the custom trackable identifier 506 may identify palm, finger, object, etc. as the custom gesture output for feeding to a gesture trackable set aggregator 508. Thus, the output of both entities, i.e., the facial expression identifier 504 (i.e., the facial expressions such as anger, happiness, etc.) and the custom trackable identifier 506 (i.e., palm, finger, object, etc.) may be fed to the gesture trackable set aggregator 508. The gesture trackable set aggregator 508 aggregates the inputs from both entities and extracts a trackable gesture set, a gesture identified, and a gesture type, from the inputs, for further processing. Further, the gesture trackable set aggregator 508 may also facilitate generation of one or more trackable focus areas vectors for the custom gestures i.e., face, palm, finger, object, etc. Finally, the output from the focus area identifier 204 is generated by tracking and converting trackable focus area motion from frame to frame in a same batch to a vector (between 0 to 1). This vector includes inputs from the trackable body focus area sets generated by the body trackable identifier 502, trackable focus areas vectors generated by the body trackable identifier 502, and the set of trackable gesture set, a gesture identified, and a gesture type generated by the gesture trackable set aggregator 508. Thus, in an embodiment, the final output vector from the focus area identifier 204 includes:

[{Trackable Gesture Set: ““}, {Gesture Identified: ““}], {Gesture Type: ““}, {Trackable Body focus Area Set: ““}, {Trackable Vectors: ““}]]

Thus, as explained above, in an embodiment, the identification of the set of key focus areas using the multi-focus recognition system includes processing, the one or more frames associated with the video stream, and at least one of the one or more activities and the one or more activity categories using at least one of the body tracking system 502, the facial expression tracking system 504 and the object tracking system 506. Further, the identification of the set of key focus areas using the multi-focus recognition system includes identifying, at least one of: (a) a set of trackable body focus areas based on the processing of the one or more frames associated with the video stream, and at least one of the one or more activities and the one or more activity categories using the body tracking system, (b) a first set of trackable focus area vectors based on the processing of the one or more frames associated with the video stream, and at least one of the one or more activities and the one or more activity categories using the body tracking system 502, (c) a second set of trackable focus area vectors based on the processing of the one or more frames associated with the video stream, and at least one of the one or more activities and the one or more activity categories using the facial expression tracking system 504 and the object tracking system 506, and (d) a set of identified gestures, a set of trackable gestures, and a set of gesture types based on the processing of the one or more frames associated with the video stream, and at least one of the one or more activities and the one or more activity categories using the facial expression tracking system 504 and the object tracking system 506. Further, the identification of the set of key focus areas using the multi-focus recognition system includes identifying, the set of key focus areas based on at least one of the set of trackable body focus areas, the first set of trackable focus area vectors, the second set of trackable focus area vectors, the set of identified gestures, the set of trackable gestures, and the set of gesture types.

Referring to FIG. 6, an example functionality of an example focus priority system 206 for an application of real-time frame adjustment on a video stream, in accordance with one or more embodiments of the present disclosure. After identification of the set of key focus areas by the focus area identifier 204, the focus priority system 206 may prioritize one or more key focus areas from the set of key focus areas. In an embodiment, the one or more key focus areas are prioritized based on at least one of an effect intensity and the one or more activity categories. The focus priority system 206 intelligently decides which focus area(s) to prioritize among other for tracking. As shown in FIG. 6, the focus priority system 206 receives input from the activity understanding module 202 (which identifies activities likes dance, vlog, podcast, interview, etc.), and the focus area identifier 204 (which identifies activity based focus area(s) like different body parts (neck, head, legs, hands) or object (like cup, pen), facial expressions, etc.). For each frame (i.e., each frame of the one or more batches of the one or more frames of the video stream), the focus priority system 206 prioritizes and filters a list of identified focus landmarks and finally selects a predicted final focus area based on the activity type, effect intensity and multiple focus areas. In an embodiment, this effect intensity is one of a user defined effect intensity and an automatically defined effect intensity. For example, the activity type is a dance video, and the effect intensity is set high (set either by the user or the system itself; also, the effect intensity here, may refer to the scene intensity. For example, for a dance video, the scene intensity may be ‘fast’ or say, the effect intensity may be ‘high’, etc. In other words, the effect intensity may be a parameter indicating an amount of movement in the video frames) and multiple focus areas in the video include face of a dancer, legs of the dancer, hands of the dancer, and flowers in the dancer's hands. Now, these activity type, effect intensity, and multiple focus areas may be used to predict the final focus area. For this purpose, the focus priority system 206 may use AI neural network model 602 (or the artificial intelligence (AI) based priority identifier neural engine 602). For example, the final focus area has been predicted as the face of the dancer. In an embodiment, the prioritization is performed at a frame level, i.e., for each frame one by one or in parallel for multiple frames, by using an artificial intelligence (AI) based priority identifier neural engine 602, which is trained based on at least one of a plurality of activity categories, a plurality of activity intensities, a plurality of trackable body focus areas, a plurality of gestures, a plurality of trackable gestures, a plurality of gesture types, and a plurality of trackable focus area vectors. Further, the output of the focus priority system 206 is in the form of a locked focus area, i.e., continuing with the above example where the final focus area has been predicted as the face of the dancer, the face of the dancer is locked with the focus so that the face does not move out of focus in the frame(s).

Referring to FIG. 7 which illustrates an example training process of an artificial intelligence (AI) neural network model inside the example focus priority system 206 for an application of real-time frame adjustment on a video stream, in accordance with one or more embodiments of the present disclosure. In an embodiment, the training of the focus priority system 206, or the AI neural network model 602 inside the focus priority system 206 is based on a time lapsed feature extraction that is done batch-wise for the one or more time lapsed frames. Here, the number of frames per batch can be controlled by the effect intensity set by the user. As shown in FIG. 7, the activity/scene category is ‘dance’, activity intensity is ‘fast’, trackable body focus area set includes ‘head, nose, shoulder, hip, legs, fingers, etc.’, trackable gesture set includes ‘wink, snap, hand pointing, etc.’, gesture identified is ‘no’, and gesture type is ‘NA’ along with vector for each trackable focus area representing motion intensity (from 0 to 1) is taken and added to a trackable focus area trajectory vector. These are associated with a training label, for example, hip (as shown in FIG. 7) and finally provided to the AI neural network model for training purposes using known training techniques. It is pertinent to note that the details depicted in the FIG. 7 are example and non-limiting.

After prioritization of the one or more key focus areas from the set of key focus areas, i.e., after the one or more areas that are to be prioritized for focusing are locked, they are tracked. In an embodiment, they are tracked by the body area tracking system 208. In an embodiment, the tracking of the one or more prioritized key focus areas includes tracking at least one of: (a) one or more actions corresponding to the one or more prioritized key focus areas, (b) one or more gestures corresponding to the one or more prioritized key focus areas, and (c) one or more motion parameters corresponding to the one or more gestures. Further, in an embodiment, the tracking of the one or more actions is performed by using a body area tracking system 208. Referring to FIG. 8, example functional details of an example body area tracking system 208 for an application of real-time frame adjustment on a video stream, in accordance with one or more embodiments of the present disclosure is shown.

In an embodiment, for tracking the one or more actions, the body area tracking system 208 may receive an input data including the one or more prioritized key focus areas, the one or more frames associated with the video stream, and a time-of-flight (ToF) data associated with the video stream. Also, the ToF data may include a depth map, and is useful for trackable focus area depth tracking. Further, the body area tracking system 208 may process the input data for determining a movement corresponding to the one or more prioritized key focus areas in the one or more frames, based on the processing of the input data. For this purpose, the locked focus area is taken as input from the focus priority system 206. This input locked focus area is fed to a pattern matching AI model 802 and a set of one or more landmark trajectory estimation models 804. In an embodiment, the pattern matching AI model 802 is a feed forward neural network. For example, the face of a dancer is locked as the prioritized key focus area. This is fed as input to the set of one or more landmark trajectory estimation models 804. The set of one or more landmark trajectory estimation models 804 detects and tracks a vertical motion and a horizontal motion of the locked focus landmark, i.e., the prioritized key focus area. This detection and tracking of the vertical motion and the horizontal motion the prioritized key focus area is performed for a previous batch as well as a current batch of the time lapsed frames of the video stream. Range of the horizontal motion of the prioritized key focus area and the vertical motion of the prioritized key focus area is output from the set of one or more landmark trajectory estimation models 804. In an embodiment, the body area tracking system 208 may track one or more trackable focus area depths based on the processing of the input data and the movement corresponding to the one or more prioritized key focus areas. Thus, the output from the set of one or more landmark trajectory estimation models 804 is further used for tracking focus area depth tracking along with the ToF data which may be obtained by a ToF sensor. The final output after using the output from the set of one or more landmark trajectory estimation models 804 and the ToF data for tracking focus area depth tracking is a two-dimensional (2D) map of 3D points (voxels) of the locked area, i.e., the prioritized key focus area. Also, in an embodiment, the body area tracking system 208 may track the one or more actions based on the tracking of the one or more trackable focus area depths and the movement corresponding to the one or more prioritized key focus areas. For this purpose, as shown in FIG. 8, the pattern matching AI model 802 receives input from the set of one or more landmark trajectory estimation models 804 (i.e., the vertical motion and the horizontal motion of the prioritized key focus area for both the previous batch as well as the current batch of the time lapsed frames of the video stream), the locked focus area (i.e., the prioritized key focus area) from the focus priority system 206, and the 2D map of 3D points of the prioritized key focus area. Further, the pattern matching AI model 802 generates a locked area trajectory category (i.e., an action). For example, the locked area trajectory categories may be, but not limited to, ‘moving away from the camera’, ‘coming forward to the camera’, going backward from the camera', ‘jumping up’, ‘sitting down’, etc. Further, the generated locked area trajectory category is fed to the intelligent effect recommender 212 (or the intelligent output recommendation system 212). Thus, in an embodiment, the body area tracking system 208 tracks and converts trackable focus area motion from frame to frame in same batch and previous batch to vector (between 0-1).

Also, the tracking of at least one of the one or more gestures and the one or more motion parameters is performed using a gesture tracking system 210. Referring to FIG. 9, example functional details of an example gesture tracking system 210 for an application of real-time frame adjustment on a video stream, in accordance with one or more embodiments of the present disclosure is shown. In an embodiment, the gesture tracking system 210 is responsible for: (a) optical flow frame sampling, i.e., converting into short motion video frames with respect to moving subjects, (b) key frame extraction by using input from locked focus area (i.e., the prioritized key focus area) from the focus priority system 206, and (c) categorizing the recognized gesture(s) from the set of supported gestures like finger snap, hand wave, eye blink, raised eyebrows, etc.

In an embodiment, for tracking of at least one of the one or more gestures and the one or more motion parameters the gesture tracking system 210 may process the one or more prioritized key focus areas, and the one or more frames associated with the video stream. For this processing, in an embodiment, the gesture tracking system 210 may perform an optical flow frame sampling process on the one or more frames. Further, the output generated by performing the optical flow frame sampling process is used for performing an optical flow key frame extraction process and finally, a frame data extraction process is performed. With these processes, a set of temporal and spatial dimension characteristics are generated for the one or more batches of the one or more time lapsed frames of the video stream. That is, in an embodiment, the gesture tracking system 210 determines at least one of a set of spatial dimension characteristics corresponding to a set of gestures, and a set of temporal dimension characteristics corresponding to the set of gestures. The gesture tracking system 210, in an embodiment, implements an artificial intelligence (AI) based three-dimensional convolutional neural network (3D CNN) model/engine 902 that is trained based on a plurality of video frames including of a plurality of gestures. This video frames may include some custom and some standard gesture set video frames. Further, the gesture tracking system 210 may track at least one of the one or more gestures and the one or more motion parameters, based on at least one of the set of spatial dimension characteristics and the set of temporal dimension characteristics. This is based on the output generated by the AI based 3D CNN model 902, which generates a gesture trajectory category. Thus, the final output from the gesture tracking system 210, i.e., the locked area trajectory category (for example, the first clenching gesture, as shown in FIG. 9) is fed to the intelligent effect recommender 212.

Referring to FIG. 10, example functional details of an example intelligent effect recommender 212 for an application of real-time frame adjustment on a video stream, in accordance with one or more embodiments of the present disclosure is shown. The intelligent effect recommender 212 may receive inputs from the body area tracking system 208 and the gesture tracking system 210, and the activity understanding module 202. The intelligent effect recommender 212, in an embodiment, is responsible for determining/recommending one or more target actions) and one or more target effects based on at least one of the tracking of the one or more prioritized key focus areas, the set of key focus areas, and the one or more activity categories. A target action, as used herein, may refer to a type of animation effect to be applied to a frame. For example, an action may include, but not limited to, zoom in, zoom out, panning in, panning out, rotate, translate, fly in, transform, fade, pulse, etc. Further, a target effect, as used herein, may refer to a type of view animation classes. For example, a target effect may include, but not limited to, overshooting, bouncy, accelerate, decelerate, cyclic, anticipatory, linear, path traversal, etc. In an example, the intelligent effect recommender 212 receives the following inputs:
Focus Priority System output: Head
Gesture Tracking System Output: NA
Locked Area Trajectory Output: Jumping Up.

Based on the above example inputs, the intelligent effect recommender 212 may generate the following example output:
Target Effect: Overshooting
Target Action Applied: Vertical Panning.

In another example, the intelligent effect recommender 212 receives the following inputs:
Focus Priority System output: Fingers
Gesture Tracking System Output: Snap
Locked Area Trajectory Output: NA.

Based on the above example inputs, the intelligent effect recommender 212 may generate the following example output:
Target Effect: Linear
Target Action Applied: Zoom In.

In an embodiment, the determination of the one or more target actions and the one or more target effects is based on the tracking of at least one of the one or more actions, the one or more gestures, and the one or more motion parameters. Also, in an embodiment, the determination of at least one of the one or more target effects and the one or more target actions is performed using an artificial intelligence (AI) based recommender neural network model/engine 1002. Also, in an embodiment, the AI based recommender neural network model 1002 is trained based on at least one of a plurality of activity categories, a plurality of activity intensities, a plurality of activity vicinities, a number of faces, a plurality of prioritized key focus areas, a plurality of gestures, a plurality of gesture types, a plurality of actions, and a plurality of motion parameters, the details of which are explained with reference to FIG. 11.

Referring to FIG. 11, an example training process of an artificial intelligence (AI) neural network model inside the example intelligent effect recommender for an application of real-time frame adjustment on a video stream, in accordance with one or more embodiments of the present disclosure is shown. The sample training data can be collected from open internet or from any other such source appreciated by to a person skilled in the art in light of the present disclosure. For example, as shown in FIG. 11, various features may be used for training the AI based recommender neural network model 1002, such as, but not limited to, activity/scene metadata features, locked focus area metadata features, and motion trajectory data features. Also, the activity metadata features may include parameters, such as, but not limited to, an activity category (or referred as scene category), an activity intensity (or referred as a scene intensity), an activity vicinity (or referred as scene vicinity), and a number of faces. Also, the locked focus area metadata features may include parameters, such as, but not limited to, a locked focus, a gesture identified, and a gesture type. Also, the motion trajectory data features may include parameters, such as, but not limited to, a locked area trajectory, and a gesture trajectory. These features along with training label, for example, the target action, and the target effect, may be taken for the training of the AI based recommender neural network model 1002. It is pertinent to note that the details depicted in the FIG. 11 are example and non-limiting.

Embodiments of the present disclosure may be implemented as a non-transitory computer readable storage medium storing instructions for an application of real-time frame adjustment on a video stream, the instructions include executable code which, when executed by one or more processors of an electronic apparatus or a system, causes the electronic apparatus to obtain or receive, in real-time, one or more frames associated with the video stream. Further, the executable code, when executed further causes the electronic apparatus 100 102 to identify one or more activities from the one or more frames. Further, the executable code, when executed further causes the electronic apparatus 100 prioritize one or more key focus areas from a set of key focus areas in the one or more identified activities. Further, the executable code, when executed further causes the electronic apparatus 100 to determine at least one of one or more target actions and one or more target effects, based on at least one of: a tracking of the one or more prioritized key focus areas, the set of key focus areas, and one or more activity categories of the one or more activities. Further, the executable code, when executed further causes the electronic apparatus 100 to apply, in real-time, at least one of the one or more target effects and the one or more target actions on one or more frames of the video stream.

Thus, the present disclosure provides a novel solution real-time frame adjustment/modification on a video stream. The present solution facilitates providing real time application of dynamic effects in a video stream like synchronized frame movement with respect to any object or a body part in the video. Further, the present solution enables one to apply frame movement effects as per the live activity, with reduced manual efforts. Further, the present solution enables identifying trackable focus areas in video frames, and intelligently prioritizing the focus areas for tracking, in real time. Also, the present solution further provides solution for real time detection and tracking of vertical, horizontal, and depth motion of a locked focus landmark. Finally, the present solution intelligently recommends in real time, effects for frame movement based on the focus area movements and is therefore technically advanced in view of the related art solutions. Further, the present solution also finds application in AR enabled devices that use locked in stabilization effects to track virtual objects or characters in the real-world environment captured by camera. This may enhance the integration of virtual elements with users' surroundings, creating compelling AR experiences for gaming, education, and navigations, etc. Further, based on the present disclosure, in sports broadcasting, camera follow effects may be used to track movements of athletes during live events, providing viewers with dynamic and immersive coverage. By automatically following the action on the field or court using the solution as disclosed in the present disclosure, broadcasters can capture key moments and deliver engaging sports content to the audience.

While considerable emphasis has been placed herein on the example embodiments, it will be appreciated that many embodiments can be made and that many changes can be made in the example embodiments without departing from the principles of the disclosure. These and other changes in the example embodiments of the disclosure will be apparent to those skilled in the art from the disclosure herein, whereby it is to be distinctly understood that the foregoing descriptive matter to be implemented merely as illustrative of the disclosure and not as limitation.

What is claimed is:

1. A method for real-time frame adjustment on a video stream, the method comprising:
obtaining, in real-time, one or more frames of the video stream;
identifying one or more activities from the one or more frames;
prioritizing one or more key focus areas from a set of key focus areas in the one or more activities;
determining at least one of one or more target actions and one or more target effects, based on at least one of: a tracking of the one or more prioritized key focus areas, the set of key focus areas, and one or more activity categories of the one or more activities; and
applying, in real-time, at least one of the one or more target effects and the one or more target actions to the one or more frames of the video stream.

2. The method as claimed in claim 1, wherein the video stream is a live camera feed video stream.

3. The method as claimed in claim 1, wherein the identifying the one or more activities comprises classifying the one or more activities in the one or more activity categories based on an analysis of the one or more frames using an artificial intelligence (AI) based activity classification engine.

4. The method as claimed in claim 1, further comprising identifying the set of key focus areas in the one or more activities based at least on the one or more activity categories.

5. The method as claimed in claim 1, wherein the prioritizing the one or more key focus areas comprises prioritizing the one or more key focus areas from the set of key focus areas based on at least one of an effect intensity and the one or more activity categories.

6. The method as claimed in claim 1, wherein the tracking the one or more prioritized key focus areas comprises tracking at least one of:
one or more actions corresponding to the one or more prioritized key focus areas,
one or more gestures corresponding to the one or more prioritized key focus areas, and
one or more motion parameters corresponding to the one or more gestures.

7. The method as claimed in claim 6, wherein the determining the at least one of the one or more target actions and the one or more target effects is further based on the tracking of at least one of the one or more actions, the one or more gestures, and the one or more motion parameters.

8. The method as claimed in claim 4, wherein the identifying the set of key focus areas is performed using a multi-focus recognition system comprising of at least one of a body tracking system, a facial expression tracking system and an object tracking system, and
wherein each key focus area from among the set of key focus areas is one of a body part, an object and a facial expression.

9. The method as claimed in claim 1, wherein the prioritizing the one or more key focus areas is performed at a frame level and by using an artificial intelligence (AI) based priority identifier neural engine.

10. The method as claimed in claim 5, wherein the effect intensity is one of a user defined effect intensity and an automatically defined effect intensity.

11. The method as claimed in claim 6, wherein the tracking the one or more actions is performed by using a body area tracking system, and
wherein the tracking of at least one of the one or more gestures and the one or more motion parameters is performed using a gesture tracking system.

12. The method as claimed in claim 1, wherein the determining the at least one of the one or more target effects and the one or more target actions is performed using an artificial intelligence (AI) based recommender neural engine.

13. The method as claimed in claim 3, wherein the analysis of the one or more frames using the artificial intelligence (AI) based activity classification engine comprises classifying the one or more frames into the one or more activities using at least one of:
one or more three-dimensional convolutional neural network (3D CNN) engines, wherein each 3D CNN engine from among the one or more 3D CNN engines is pre-trained based on a plurality of activities, and
one or more Visual Question Answering (VQA) engines.

14. The method as claimed in claim 8, wherein the identifying the set of key focus areas comprises:
processing, the one or more frames of the video stream, and at least one of the one or more activities and the one or more activity categories using at least one of the body tracking system, the facial expression tracking system and the object tracking system,
identifying, at least one of:
a set of trackable body focus areas based on the processing the one or more frames of the video stream, and at least one of the one or more activities and the one or more activity categories using the body tracking system,
a first set of trackable focus area vectors based on the processing the one or more frames of the video stream, and at least one of the one or more activities and the one or more activity categories using the body tracking system,
a second set of trackable focus area vectors based on the processing the one or more frames of the video stream, and at least one of the one or more activities and the one or more activity categories using the facial expression tracking system and the object tracking system, and
a set of identified gestures, a set of trackable gestures, and a set of gesture types based on the processing the one or more frames of the video stream, and at least one of the one or more activities and the one or more activity categories using the facial expression tracking system and the object tracking system, and
identifying the set of key focus areas based on at least one of the set of trackable body focus areas, the first set of trackable focus area vectors, the second set of trackable focus area vectors, the set of identified gestures, the set of trackable gestures, and the set of gesture types.

15. The method as claimed in claim 9, wherein the AI based priority identifier neural engine is trained based on at least one of a plurality of activity categories, a plurality of activity intensities, a plurality of trackable body focus areas, a plurality of gestures, a plurality of trackable gestures, a plurality of gesture types, and a plurality of trackable focus area vectors.

16. An electronic apparatus comprising:
a camera;
at least one processor; and
memory comprising one or more storage mediums storing instructions,
wherein the one or more instructions, when executed by the at least one processor individually or collectively, cause the electronic apparatus to:
obtain, in real-time using the camera, one or more frames of the video stream,
identify one or more activities from the one or more frames,
prioritize one or more key focus areas from a set of key focus areas in the one or more activities,
determine at least one of one or more target actions and one or more target effects, based on at least one of: a tracking of the one or more prioritized key focus areas, the set of key focus areas, and one or more activity categories of the one or more activities, and
apply, in real-time, at least one of the one or more target effects and the one or more target actions to the one or more frames of the video stream.

17. The electronic apparatus as claimed in claim 16, wherein the video stream is a live video stream.

18. The electronic apparatus as claimed in claim 16, wherein the one or more instructions, when executed by the at least one processor individually or collectively, cause the electronic apparatus to classify the one or more activities in the one or more activity categories based on an analysis of the one or more frames using an artificial intelligence (AI) based activity classification engine.

19. The electronic apparatus as claimed in claim 16, wherein the one or more instructions, when executed by the at least one processor individually or collectively, cause the electronic apparatus to identify the set of key focus areas in the one or more activities based at least on the one or more activity categories.

20. A non-transitory computer readable storage medium storing instructions that when executed by at least one processor of an electronic device cause the electronic device to perform a method for real-time frame adjustment on a video stream, the method comprising:
obtaining, in real-time, one or more frames of the video stream;
identifying one or more activities from the one or more frames;
prioritizing one or more key focus areas from a set of key focus areas in the one or more activities;
determining at least one of one or more target actions and one or more target effects, based on at least one of: a tracking of the one or more prioritized key focus areas, the set of key focus areas, and one or more activity categories of the one or more activities; and
applying, in real-time, at least one of the one or more target effects and the one or more target actions to the one or more frames of the video stream.
